(19) United States
(12) Patent Application Publication
(10) Pub. No.: US 2006/0078674 A1
(43) Pub. Date: Apr. 13, 2006

(54) Device and method for producing sheet for abrasive coating and the sheet

(75) Inventor: Minoru Ohara, Hyogo (JP)

Correspondence Address: WENDEROTH, LIND & PONACK, L.L.P., 2033 K STREET N. W., SUITE 800, WASHINGTON, DC, 20006-1021, US

(73) Assignee: Mitsubishi Heavy Industries, Ltd., Tokyo (JP)

(21) Appl. No.: 10/515,438

(22) PCT Filed: Nov. 27, 2003
(86) PCT No.: PCT/JP03/15148

§ 371 Date: Nov. 23, 2004

(30) Foreign Application Priority Data
Nov. 27, 2002 (JP) 2002-343574

(51) Int. Cl. B05C 11/02; E01F 9/04; B05D 1/36

(52) U.S. Cl. 427/201; 118/100; 428/143

(57) ABSTRACT

A sheet pan (120) having a groove (121), into which a brazing sheet is fitted, is disposed on a base (110). A slide member (140) can slidingly move along the longitudinal direction of the sheet pan (120) at a position above the sheet pan (120). A blade (160) is moved upward and downward by a micrometer (170) fixed to and supported by the slide member (140). A brazing sheet is fitted into the groove (121), and coated with an abrasive coating material. The slide member (140) is slid, with the clearance between the blade (160) and the sheet pan (110) being adjusted using the micrometer (170). As a result, a surplus of the abrasive coating material is scraped off, and the abrasive coating material becomes uniform in thickness. Thus, an abrasive coating sheet high in quality and uniform in the thickness of the abrasive coating material can be produced conveniently.

### TECHNICAL FIELD

This invention relates to an apparatus and method for producing an abrasive coating sheet, as well as an abrasive coating sheet, the apparatus and method being designed to be capable of producing an abrasive coating sheet, with the thickness of an abrasive coating material being uniform.

### BACKGROUND ART

In a gas turbine, a predetermined clearance is provided between a moving blade tip and a casing opposed to the moving blade tip. With the gas turbine, a high temperature combustion gas flows through a gas passage, so that the moving blade thermally elongates. If this thermal elongation becomes marked, the event that the tip of the moving blade and the casing make contact may occur.

To ensure reliability even if such contact occurs, a hard abrasive coating is applied to the tip of the moving blade, while an abradable coating, which can be easily shaved off, is applied to the casing. Because of these measures, even if the tip of the moving blade contacts the casing, the hard abrasive coating at the tip of the moving blade shaves off the easily scrapable abradable coating applied on the casing. Thus, reliability can be ensured, and a proper clearance can be secured (see, for example, Japanese Patent Application Laid-Open No. 2001-303904).

CBN/MCrAlY is often used as the abrasive coating. In this coating, cubic boron nitride (CBN) functions as polishing grains, and MCrAlY serves as a matrix metal to set the polishing grains in place. M in the MCrAlY denotes one or more metals among iron, nickel and cobalt.

One of methods for applying the abrasive coating at the tip of the moving blade is the use of an abrasive coating sheet. The procedure for production of the abrasive coating sheet, and the method of coating with the abrasive coating sheet will be explained with reference to FIGS. 3(a) to 3(d).

First, a commercially available brazing sheet 1 is rendered ready for use, as shown in FIG. 3(a). “BNi-2” complying with the JIS standards, for example, is adopted as the brazing sheet 1. The brazing sheet 1 is formed by laminating a brazing filler metal layer 1a, a pressure sensitive adhesive layer 1b, and a backing sheet 1c.

Then, as shown in FIG. 3(b), an abrasive coating material 2 in the form of a slurry is coated onto the brazing filler metal layer 1a of the brazing sheet 1. The abrasive coating material 2 is a mixture of a binder 2a, MCrAlY 2b, and CBN 2c. Then, the abrasive coating material 2 is spread in a sheet form by a blade or the like, and during this action, a surplus of the abrasive coating material 2 is scraped off. Such an operation for spreading the abrasive coating material 2 in a sheet form by a blade or the like has hitherto been performed by manual work of an operator.

When the slurried abrasive coating material 2, which has been coated and spread on the brazing filler metal layer 1a of the brazing sheet 1, is dried, an abrasive coating sheet 3 is formed.

The resulting abrasive coating sheet 3 is cut along the shape of a moving blade, whereafter the backing sheet 1c is peeled off, and the residue is stuck to the tip of the moving blade. In this state, the abrasive coating sheet 3 (stripped of the backing sheet 1c) is heated together with the moving blade. As a result, a solidified layer 4 having the CBN 2c dispersed in a matrix metal 2b′ of MCrAlY is formed, as shown in FIG. 3(c). In FIG. 3(c), 5 denotes a moving blade.

When the solidified layer 4 is subjected to blasting, the CBN 2c protrudes from the matrix metal 2b′, as shown in FIG. 3(d), whereby so-called “dressing” is achieved. In this manner, an abrasive coating 6 is formed.

According to conventional technologies, the abrasive coating material 2 coated onto the brazing sheet 1 was spread in a sheet form by a manual operation performed by an operator using a blade or the like. Thus, variations in the film thickness were so great that the yield was very low, and accordingly a final construction cost was increased.

Conventionally, when a 1 m long sheet was to be produced, a blade was moved manually at a rate of several millimeters/sec. Thus, another person had to be assigned to an operation for slurry supply, leading to high labor costs.

Moreover, the abrasive coating sheet 3 was produced by a manual operation. To minimize the variations in the film thickness, therefore, some expertise was required. If the operator changed, variations in the film thickness (deterioration of quality) immediately resulted.

The doctor blade process, which is generally accepted, poses the drawback that the slurry cannot be spread in a sheet form if its viscosity is high. The doctor blade process is difficult to apply for the viscosity of the slurry put to the present uses (the viscosity is high).

In view of the above-described conventional technologies, the present invention has as an object the provision of an apparatus and method for producing an abrasive coating sheet, the apparatus and method being capable of producing the abrasive coating sheet without variations in the film thickness; and the provision of the abrasive coating sheet.

### DISCLOSURE OF THE INVENTION

To attain the above object, the apparatus for producing an abrasive coating sheet according to the present invention comprises: a base; a sheet pan placed on the base, the sheet pan having formed therein a groove into which a brazing sheet is fitted; a slide member placed on the base so as to be slidable in a longitudinal direction of the sheet pan at a position above the sheet pan; a blade slidably disposed in the slide member so as to be brought close to and away from the groove of the sheet pan; and a height adjusting mechanism for adjusting the height of the blade from the sheet pan by sliding the blade.

The apparatus for producing an abrasive coating sheet according to the present invention also comprises: a base; a sheet pan placed on the base, the sheet pan having formed therein a groove into which a brazing sheet is fitted; a slide member placed on the base so as to be slidable in the longitudinal direction of the sheet pan at a position above the sheet pan; a blade slidably disposed in the slide member so as to be brought close to and away from the groove of the sheet pan; a height adjusting mechanism for adjusting the height of the blade from the sheet pan by sliding the blade; and clearance measuring means for measuring a clearance between the sheet pan and the blade.

The apparatus for producing an abrasive coating sheet according to the present invention is also characterized by including a sliding movement mechanism for slidingly moving the slide member relative to the base.

The method for producing an abrasive coating sheet according to the present invention comprises: the step of fitting a brazing sheet into a groove of a sheet pan, and holding down the brazing sheet by a sheet hold-down member; the step of setting the height of a blade, which is slid along the upper surface of the sheet pan, at a desired position with respect to the upper surface of the sheet pan; the step of supplying a predetermined amount of an abrasive coating material onto the brazing sheet; and the step of sliding the blade at a constant speed along the upper surface of the sheet pan, while keeping the height of the blade relative to the upper surface of the sheet pan at the height position, thereby coating the abrasive coating material onto the brazing sheet.

The method for producing an abrasive coating sheet according to the present invention is also characterized in that in the step of supplying the predetermined amount of the abrasive coating material onto the brazing sheet, the abrasive coating material is not supplied at one time, but is supplied at intervals of 70 to 80 mm.

The method for producing an abrasive coating sheet according to the present invention is also characterized in that the slide speed of the blade is 1 to 5 mm/second.

The method for producing an abrasive coating sheet according to the present invention is also characterized in that the blade is slid while being tilted at a blade angle of 30 to 60 degrees with respect to the upper surface of the brazing sheet.

The abrasive coating sheet according to the present invention is characterized by being produced by any one of the above-described methods.

### BRIEF DESCRIPTION OF THE DRAWINGS

FIG. 1 is a plan view showing an apparatus for producing an abrasive coating sheet according to the present invention.

FIG. 2 is a side view showing the apparatus for producing the abrasive coating sheet of the present invention.

FIGS. 3(a) to 3(d) are explanation views showing the procedure for producing the abrasive coating sheet, and the method of coating with this abrasive coating sheet.

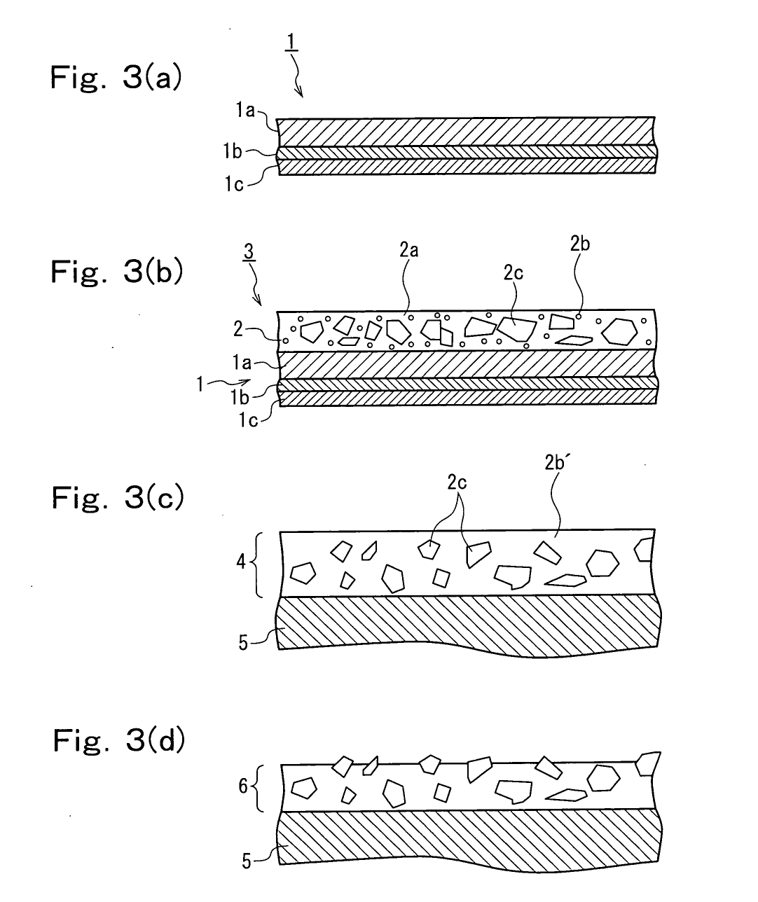

### BEST MODE FOR CARRYING OUT THE INVENTION

The best mode for carrying out the present invention will now be described in detail with reference to the drawings.

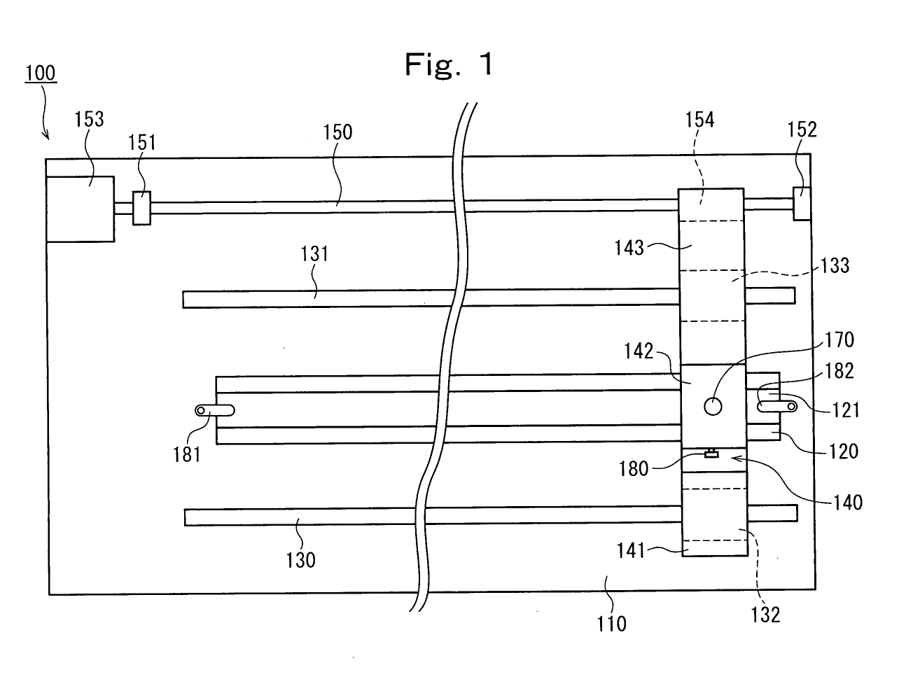

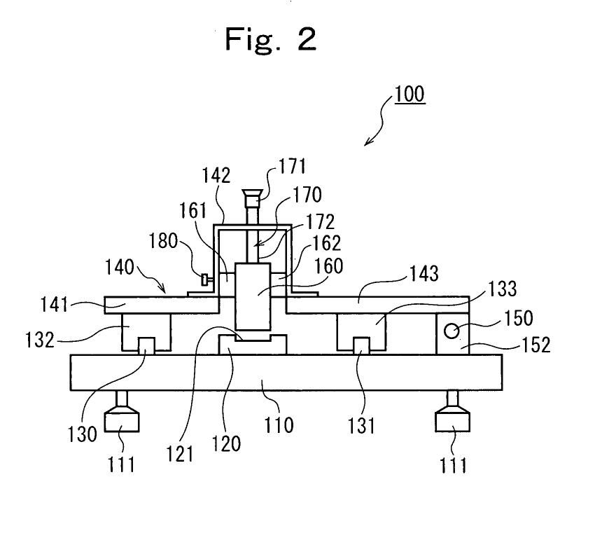

FIG. 1 is a plan view showing an apparatus 100 for producing an abrasive coating sheet according to the best embodiment of the present invention. FIG. 2 is a right side view of the apparatus 100.

As shown in these drawings, a plurality of adjustors 111 are attached to the bottom surface of a base 110 for correcting and adjusting the tilt of the base 110. A sheet pan 120 of continuous length is placed on the upper surface of the base 110. A groove 121, which is an elongated groove, is formed in the upper surface of the sheet pan 120. The width of the groove 121 is defined so that a brazing sheet (not shown) can be tightly fitted into the groove 121 of the sheet pan 121.

A pair of linear rails 130, 131 are laid on the upper surface of the base 110. These linear rails 130, 131 are placed parallel to the sheet pan 120 while interposing the sheet pan 120 therebetween.

A slide member 140 is an integral member having rigidity, which is constituted by firmly connecting together a flat material 141, a gate-shaped material 142, and a flat material 143 by bolts. A bearing block 132, which straddles the linear rail 130 and rolls along the linear rail 130, is fixed to the bottom surface of the flat material 141. A bearing block 133, which straddles the linear rail 131 and rolls along the linear rail 131, is fixed to the bottom surface of the flat material 143. Thus, the slide member 140 can slidingly move along the longitudinal direction of the sheet pan 120 at a position above the sheet pan 120. In this case, play between the linear rails 130, 131 and the bearing blocks 132, 133 straddling the linear rails 130, 131 is extremely small, so that the play of the slide member 140 is also extremely small.

A ball screw 150 is rotatably supported by ball screw holders 151, 152, and placed on the upper surface of the base 110. This ball screw 150 rotates under the rotating force of a drive motor 153. A geared motor, for example, is employed as the drive motor 153, and its rotational speed is controlled by an inverter. A nut portion 154 screwed over the ball screw 150 is fixed to the lower surface of the flat material 143. As a result, when the ball screw 150 is rotated by the drive motor 153, its rotational movement is converted by the nut portion 154 into a linear movement, whereby the slide member 140 can make a sliding movement. The sliding movement speed of the slide member 140 (namely, the sliding movement speed of a blade 160 to be described later) is set at about 1 to 5 mm/sec. In short, the members 150 to 154 constitute a sliding movement mechanism.

The blade 160, as shown in FIG. 2, can slidably move in an up-and-down direction relative to the gate-shaped material 142, while having both sides thereof guided by guides 161, 162. This blade 160 has nearly the same width as that of the groove 121 of the sheet pan 120, and can move close to and away from the groove 121. That is, the height of the blade 160 varies, thereby changing the clearance between the lower side of the blade 160 and the groove surface of the groove 121.

At this time, the blade 160 can slidably move up and down, with the blade 160 being tilted at an angle of 30 to 60 degrees with respect to the groove surface of the groove 121 (i.e. the upper surface of the brazing sheet to be fitted into this groove). As a result, when the slide member 140 slidingly moves, the blade 160 can be slidingly moved while being tilted at an angle of 30 to 60 degrees with respect to the upper surface of the brazing sheet.

A micrometer 170 is fixed to and supported by the gate-shaped material 142, and has its lower end fixed to the upper side of the blade 160. Thus, when a rotary portion 171 of the micrometer 170 is rotated, a shaft 172 advances and retreats in the up-and-down direction, and the height of the blade 160 is adjusted accordingly. Also, the micrometer 170 can measure the clearance between the lower side of the blade 160 and the groove surface of the groove 121.

In this example, the micrometer 170 combines a height adjusting mechanism for adjusting the height of the blade 160, with a clearance measuring means for measuring the clearance between the sheet pan 120 and the blade 160.

When a locking screw 180 is screwed in, the blade 160 is locked, and its height is fixed. At both ends of the sheet pan 120, sheet hold-down clamps 181, 182 of a spring type are provided. When the brazing sheet is tightly fitted into the groove 121 of the sheet pan 120, the opposite ends of the brazing sheet are held down by the sheet hold-down clamps 181, 182.

To produce an abrasive coating sheet by the apparatus 100 for producing an abrasive coating sheet, which is configured as described above, the slide member 140 is first retreated to the endmost position. In this state, the brazing sheet is tightly fitted into the groove 121 of the sheet pan 120, and the opposite ends of the brazing sheet are held down by the sheet hold-down clamps 181, 182.

Then, the rotary portion 171 of the micrometer 170 is rotated to adjust the height of the blade 160. At this time, the clearance between the lower side of the blade 160 and the groove surface of the groove 121, as measured by the micrometer 170, is set to have a predetermined length.

An abrasive coating material (slurry) is coated onto the brazing sheet. After coating, the drive motor 153 is driven to move the slide member 140 at a constant speed along the sheet pan 120 from its one end to the other end. By so doing, the blade 160 spreads the slurry while maintaining a constant clearance from the groove surface of the groove 121. It is important here that the slurry not be supplied at one time, but be charged (supplied) at intervals of 70 to 80 mm. Thus, the slurry remains with a constant thickness on the brazing sheet. As a result, there can be formed a high quality abrasive coating sheet having the abrasive coating material (slurry) in a constant thickness.

At this time, it is optimal to set the sliding movement speed of the blade 160 at 3 mm/second and the blade angle (blade inclination) of the blade 160 to the brazing sheet at 45 degrees. By setting the sliding movement speed and the blade angle at these values, uniform coating can be performed.

The thickness of the abrasive coating material (slurry) can be adjusted in units of 1/1000 mm by adjusting the height of the blade 160 by means of the micrometer 170. Simultaneously, this thickness can be accurately measured by the micrometer 170. Thus, the thickness of the abrasive coating material can be accurately set to be the desired thickness, and this thickness can be made uniform.

Moreover, the slide member 140 is moved by the slide mechanism (members 150 to 154). Thus, a saving in labor can be achieved, and a high quality abrasive coating sheet can be produced even by an operator who is not experienced.

According to the embodiment shown in FIGS. 1 and 2, the slide mechanism (members 150 to 154) is provided. However, there may be provided a constitution in which this slide mechanism is eliminated and the slide member 140 is moved by a manual force.

Furthermore, there may be provided a constitution in which a linear guide is employed instead of the guides 161, 162 to ensure the smooth upward and downward movement of the blade 160.

Besides, the height adjusting mechanism and the clearance measuring member can be constituted as separate members. In this case, a feed screw mechanism or the like can be adopted as the height adjusting mechanism, and a micrometer or a digital indicator can be employed as the clearance measuring means.

The present invention described above can produce the following effects:

The brazing sheet is fitted into the groove, and coated with the abrasive coating material, whereafter the slide member is moved. Merely by so doing, a high quality abrasive coating sheet having a constant abrasive coating material thickness can be formed easily.

Moreover, the thickness of the abrasive coating material can be accurately measured, and this thickness can be accurately set to be the desired thickness.

Furthermore, the slide member can be automatically moved by the slide mechanism. Thus, a saving in labor can be achieved, and a high quality abrasive coating sheet can be produced even by an operator who is not experienced.

### INDUSTRIAL APPLICABILITY

According to the present invention, as described above, an abrasive coating sheet used as a method for applying an abrasive coating can be produced with a high quality.

1. An apparatus for producing an abrasive coating sheet, comprising:
a base;
a sheet pan placed on said base, said sheet pan having formed therein a groove into which a brazing sheet is fitted;
a slide member placed on said base so as to be slidable in a longitudinal direction of said sheet pan at a position above said sheet pan;
a blade slidably disposed in said slide member so as to be brought close to and away from said groove of said sheet pan; and
a height adjusting mechanism for adjusting a height of said blade from said sheet pan by sliding said blade.

2. An apparatus for producing an abrasive coating sheet, comprising:
a base;
a sheet pan placed on said base, said sheet pan having formed therein a groove into which a brazing sheet is fitted;
a slide member placed on said base so as to be slidable in a longitudinal direction of said sheet pan at a position above said sheet pan;
a blade slidably disposed in said slide member so as to be brought close to and away from said groove of said sheet pan;
a height adjusting mechanism for adjusting a height of said blade from said sheet pan by sliding said blade; and
clearance measuring means for measuring a clearance between said sheet pan and said blade.

3. The apparatus for producing an abrasive coating sheet according to claim 1, characterized by including a sliding movement mechanism for slidingly moving said slide member relative to said base.

4. A method for producing an abrasive coating sheet, comprising the steps of:
fitting a brazing sheet into a groove of a sheet pan, and holding down said brazing sheet by a sheet hold-down member;
setting a height of a blade, which is slid along an upper surface of said sheet pan, at a desired position with respect to said upper surface of said sheet pan;
supplying a predetermined amount of an abrasive coating material onto said brazing sheet; and
sliding said blade at a constant speed along said upper surface of said sheet pan, while keeping the height of said blade relative to said upper surface of said sheet pan at said height position, thereby coating said abrasive coating material onto said brazing sheet.

5. The method for producing an abrasive coating sheet according to claim 4, characterized in that in the step of supplying the predetermined amount of said abrasive coating material onto said brazing sheet, said abrasive coating material is not supplied at one time, but is supplied at intervals of 70 to 80 mm.

6. The method for producing an abrasive coating sheet according to claim 4, characterized in that the slide speed of said blade is 1 to 5 mm/second.

7. The method for producing an abrasive coating sheet according to claim 4, characterized in that said blade is slid while being tilted at a blade angle of 30 to 60 degrees with respect to an upper surface of said brazing sheet.

8. An abrasive coating sheet characterized by being produced by the method according to claim 4.

9. The apparatus for producing an abrasive coating sheet according to claim 2, characterized by including a sliding movement mechanism for slidingly moving said slide member relative to said base.

10. An abrasive coating sheet characterized by being produced by the method according to claim 5.

11. An abrasive coating sheet characterized by being produced by the method according to claim 6.

12. An abrasive coating sheet characterized by being produced by the method according to claim 7.
